(19) United States
(12) Patent Application Publication
(10) Pub. No.: US 2009/0323755 A1
(43) Pub. Date: Dec. 31, 2009

(54) Optical resonator and laser light source

(75) Inventor: Hideaki Okayama, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/457,018

(22) Filed: May 29, 2009

(30) Foreign Application Priority Data
Jun. 30, 2008 (JP) 2008-169931

(51) Int. Cl. H01S 3/083; G02B 6/42; G02B 6/26

(52) U.S. Cl. 372/94; 385/32; 385/44

(57) ABSTRACT

An optical resonator includes an optical waveguide with a core surrounded by a clad of lower refractive index. The optical waveguide includes a non-terminated ring-type optical waveguide for resonant propagation of light and an input-output optical waveguide, unitarily coupled to the ring-type optical waveguide, for output of light from the ring-type optical waveguide, or input of light to and output of light from the optical ring waveguide. The ring-type optical waveguide and input-output optical waveguide can be formed simultaneously as silicon-wire waveguides. The unitary coupling simplifies fabrication of the optical resonator.

### BACKGROUND OF THE INVENTION

1. Field of the Invention

The present invention relates to an optical resonator and a laser light source.

2. Description of the Related Art

The drive to integrate optics with semiconductor technology has led to the use of silicon (Si) as an optical waveguide material. In a type of waveguide referred to as a silicon-wire waveguide, having a silicon core surrounded by a silicon dioxide (SiO₂) clad, the large difference in refractive index between the core and clad strongly confines light in the core. This strong confinement enables a silicon-wire waveguide to have submicron-order cross-sectional dimensions and to turn corners with a very small radius of curvature. Specifically, a silicon-wire waveguide can have a radius of curvature as small as about one micrometer (1 μm) without intolerable optical loss. Silicon-wire waveguides can accordingly be used to create optical circuits with dimensions comparable to those of silicon microelectronic devices, holding promise for the integration of optical and electronic technologies on the same chip. Optical resonators will be key components of such chips.

The optical resonators used in silicon-wire waveguide optics are generally optical ring resonators, which are comparatively easy to fabricate. The greatest technical challenge in the fabrication of an optical ring resonator lies in the geometry of the coupling between the optical ring waveguide and the optical input-output waveguide.

In U.S. Patent Application Publication No. 20080056311 (Japanese Patent Application Publication No. 2008-060445), Takeuchi et al. show a light-emitting element in which optical ring resonators are coupled to non-touching but nearly tangent linear input-output waveguides. This coupling geometry requires precise control over the spacing between the optical ring waveguides and the linear optical waveguides, so fabrication is difficult.

In order to overcome this difficulty, in Japanese Patent Application Publication No. 2004-279982 (now Japanese Patent No. 4083045) Kokubu proposes a sandwich structure in which the optical ring waveguide is interposed between a pair of optical input-output waveguides. This structure has the disadvantage of requiring a greatly increased number of fabrication steps.

In Japanese Patent Application Publication No. H5-181028 (now Japanese Patent No. 3112193), Kominato et al. disclose the use of an optical switch through which light is input to and output from the optical ring waveguide. This switching method has the disadvantages of increased device size and complicated device structure.

### SUMMARY OF THE INVENTION

An object of the present invention is to provide a simplified coupling between a ring-type optical waveguide and an input-output optical waveguide in an optical resonator.

Another object is to provide a simplified coupling between a silicon-wire ring-type optical waveguide and a silicon-wire input-output optical waveguide in an optical resonator.

A further object of the invention is to provide a laser light source including a silicon-wire ring-type optical waveguide and a silicon-wire input-output optical waveguide with a simplified coupling structure.

The invention provides an optical resonator with an optical waveguide having a core surrounded by a clad. The core has a higher refractive index than the clad. The optical waveguide includes a non-terminated ring-type optical waveguide for resonant propagation of light, and an input-output optical waveguide, unitarily coupled to the ring-type optical waveguide, for output, or input and output, of the light.

The ring-type optical waveguide may be circular, or may have a figure-eight configuration.

The input-output optical waveguide may be a single linear segment meeting the input-output optical waveguide in a T-shaped configuration, or crossing the ring-type optical waveguide at one or two locations.

Alternatively, the input-output optical waveguide may have two linear segments, each meeting or crossing the ring-type optical waveguide at a different location.

If the ring-type optical waveguide has a figure-eight configuration, the input-output optical waveguide may meet or cross the ring-type optical waveguide at the intersection point where the figure eight crosses over itself.

The core may be made of silicon and the clad of silicon dioxide. The refractive index of the core is preferably at least 1.4 times the refractive index of the clad.

A laser light source is created by providing an active region in part of the ring-type optical waveguide.

The unitary coupling between the ring-type optical waveguide and input-output optical waveguide is suitable for use when the ring-type optical waveguide and input-output optical waveguide are silicon-wire waveguides. Because of the unitary coupling, the optical ring resonator and laser light source have a simple structure that is easy to fabricate.

### BRIEF DESCRIPTION OF THE DRAWINGS

In the attached drawings:

FIG. 1 is a schematic perspective view of an optical resonator in a first embodiment of the invention;

FIG. 2 is a graph illustrating the output characteristic of the optical resonator in the first embodiment;

FIGS. 3A and 3B illustrate variations of the optical resonator in the first embodiment;

FIG. 4 is a plan view illustrating the schematic structure of an optical resonator in a second embodiment;

FIG. 5 is a graph illustrating the output characteristic of the optical resonator in the second embodiment;

FIGS. 6A, 6B, and 6C illustrate variations of the optical resonator in the second embodiment;

FIG. 7 is a plan view illustrating the schematic structure of an optical resonator in a third embodiment;

FIGS. 8A and 8B are schematic drawings illustrating light propagation paths in the optical resonator in the third embodiment;

FIG. 9 is a graph illustrating the output characteristic of the optical resonator in the third embodiment;

FIG. 10 is a plan view illustrating the schematic structure of an optical resonator in a fourth embodiment;

FIG. 11 is a graph illustrating the output characteristic of the optical resonator in the fourth embodiment; and

FIG. 12 illustrates a variation of the optical resonator in the fourth embodiment.

### DETAILED DESCRIPTION OF THE INVENTION

Embodiments of the invention will now be described with reference to the attached highly schematic, non-limiting drawings, in which like elements are indicated by like reference characters.

### First Embodiment

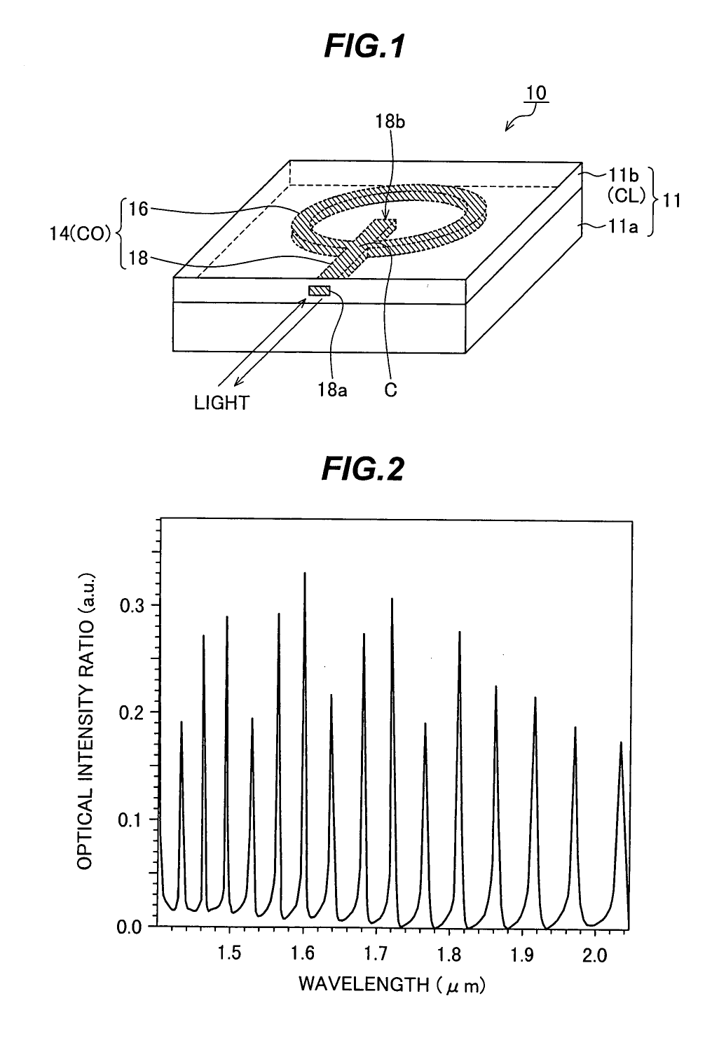

Referring to FIG. 1, the optical resonator 10 in the first embodiment includes an optical waveguide 14 and a substrate 11 having a lower layer 11a and an upper layer 11b. The substrate 11 is a flat rectangular solid body. The material of the lower layer 11a is silicon, and the material of the upper layer 11b is silicon dioxide (SiO₂). The optical waveguide 14 is indicated by hatching.

The optical waveguide 14 is formed in the upper layer 11b. The optical waveguide 14 includes a non-terminated ring-type optical waveguide 16, and an input-output optical waveguide 18 for guiding light into and out of the ring-type optical waveguide 16. The input-output optical waveguide 18 is unitarily coupled to the ring-type optical waveguide 16.

The entire optical waveguide 14 functions as a silicon-wire waveguide in which the optical waveguide 14 itself is the silicon core CO and the surrounding SiO₂ upper layer 11b is the clad CL. The clad CL has a refractive index n₁ of 1.46; the silicon core CO has a refractive index n₂ of 3.5.

The ring-type optical waveguide 16 is a ring waveguide with a square cross-section orthogonal to the direction of light propagation. Preferred cross-sectional dimensions of the ring-type optical waveguide 16 are, for example, about 0.3 μm high by 0.3 μm wide. The preferred radius of the ring formed by the ring-type optical waveguide 16 is, for example, about 3 μm.

The input-output optical waveguide 18 is a single linear segment that lies in the same plane as the ring-type optical waveguide 16 and crosses the ring-type optical waveguide 16 at a single location C on a line passing through the center of the ring formed by the ring-type optical waveguide 16.

The input-output optical waveguide 18 has a first end 18a and a second end 18b. The first end 18a is exposed on an edge facet of the upper layer 11b of the substrate 11. The second end 18b is embedded in the upper layer 11b. An antireflective structure (not indicated) is formed on the surface of the second end 18b.

Like the ring-type optical waveguide 16, the input-output optical waveguide 18 has a square cross-section with exemplary preferred cross-sectional dimensions of 0.3 μm high by 0.3 μm wide.

To prevent the light propagating through the optical waveguide 14 from leaking into the lower layer 11a, the preferred spacing between the optical waveguide 14 and the lower layer 11a of the substrate 11 is at least, for example, about 1 μm. The preferred spacing between the optical waveguide 14 and the upper surface of the upper layer 11b of the substrate 11 is, for example, about 1 μm.

Next, a method of manufacturing the optical resonator 10 will be briefly described.

In this exemplary method, the optical resonator 10 is manufactured by applying known semiconductor fabrication processes to a commercially available silicon-on-insulator (SOI) substrate having a single-crystalline silicon upper layer disposed on an SiO₂ layer. Photolithography is used to transfer the desired planar pattern of the optical waveguide 14 to the single-crystalline silicon upper layer of the substrate, leaving a single-crystalline silicon wire resting on the SiO₂ surface. An SiO₂ film is then deposited by chemical vapor deposition (CVD), covering both the SiO₂ surface and the single-crystalline silicon wire. The single-crystalline silicon wire forms the core CO of the optical waveguide 14 and the underlying SiO₂ layer and deposited SiO₂ film form the clad CL, these elements together constituting the upper layer 11b in FIG. 1.

The SOI substrate may also include a lower silicon layer which functions as the lower layer 11a in FIG. 1.

Next, the operation of the optical resonator 10 will be described.

Light enters the optical resonator 10 through the first end 18a of the input-output optical waveguide 18, propagates through the input-output optical waveguide 18 toward the ring-type optical waveguide 16, and reaches location C. Part of the light is scattered at location C and coupled into the ring-type optical waveguide 16, where it begins to circulate.

The part of the light that is not scattered at location C propagates to the second end 18b of the input-output optical waveguide 18, where it is scattered into the clad outside the input-output optical waveguide 18 because of the antireflective structure formed on the second end 18b. The purpose of the antireflective structure is to prevent parasitic resonant propagation of light between the first and second ends 18a, 18b of the input-output optical waveguide 18.

As the light coupled into the ring-type optical waveguide 16 circulates in the ring-type optical waveguide 16, light with specific wavelengths determined by the optical path length of the ring-type optical waveguide 16 is amplified by resonance. When the amplified light passes location C, part of the amplified light is scattered and coupled back into the input-output optical waveguide 18. Part of this light propagates toward the first end 18a, where it exits the input-output optical waveguide 18 as output light.

To ensure that amplified light of the desired wavelength is output through the first end 18a of the input-output optical waveguide 18, it suffices to simulate the operation of the optical resonator 10 in the design stage and adjust the optical path length of the ring-type optical waveguide 16, thereby adjusting the phase of the light, so as to maximize the output of light with the desired wavelength.

The output characteristic of the optical resonator 10 is illustrated in FIG. 2. The vertical axis indicates the ratio of the intensity of the output light exiting the first end 18a of the input-output optical waveguide 18 to the intensity of the input light entering the first end 18a of the input-output optical waveguide 18 in arbitrary units (a.u.). The horizontal axis indicates the wavelength of the light in micrometers (μm). The curve indicates how the intensity of the output light varies depending on the wavelength of the input light. This curve was obtained by simulating the operation of the optical resonator 10 by the finite-difference time-domain (FDTD) method.

Intensity peaks appear at regular intervals, forming a harmonic series of wavelengths. The optical resonator 10 therefore operates as a classical optical resonator having a single optical path length. The input-output optical waveguide 18 does not operate as a parasitic optical resonator.

As described above, the optical resonator 10 with the silicon-wire waveguide in the first embodiment has an extremely simple structure that is easy to fabricate by applying known semiconductor fabrication processes.

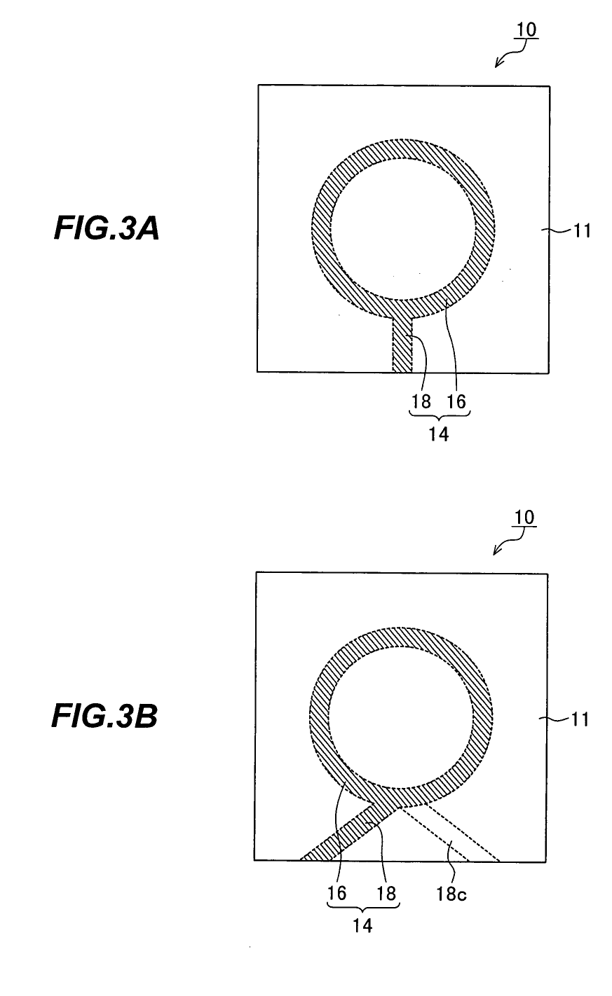

The unitary coupling between the ring-type optical waveguide 16 and the input-output optical waveguide 18 is not restricted to the geometry in which the input-output optical waveguide 18 crosses the ring-type optical waveguide 16 as described in the first embodiment. The input-output optical waveguide 18 and ring-type optical waveguide 16 may meet in a right-angled T-shaped coupling configuration instead, as shown in FIG. 3A. The unitary T-shaped coupling also provides an optical resonator 10 with a silicon-wire waveguide having a simple structure that is easy to fabricate.

It is not necessary for the input-output optical waveguide 18 to cross or meet the ring-type optical waveguide 16 on a line passing through the center of the ring formed by the ring-type optical waveguide 16 as described in the first embodiment. For example, the input-output optical waveguide 18 may lie in the same plane as the ring-type optical waveguide 16 and meet the ring-type optical waveguide 16 at an acute angle, on a line distant from the center of the ring, forming an acute-angled T-shaped coupling with a classical optical resonator shape as shown in FIG. 3B. An additional optical waveguide 18c can be placed at the connecting point between the input-output optical waveguide 18 and the ring-type optical waveguide 16 to provide a further input-output optical waveguide.

The ring-type optical waveguide 16 is not restricted to the circular geometry shown in the first embodiment. The ring-type optical waveguide 16 may follow an oval or elliptical path, for example, or a polygonal path with rounded vertices, without excessive optical loss.

### Second Embodiment

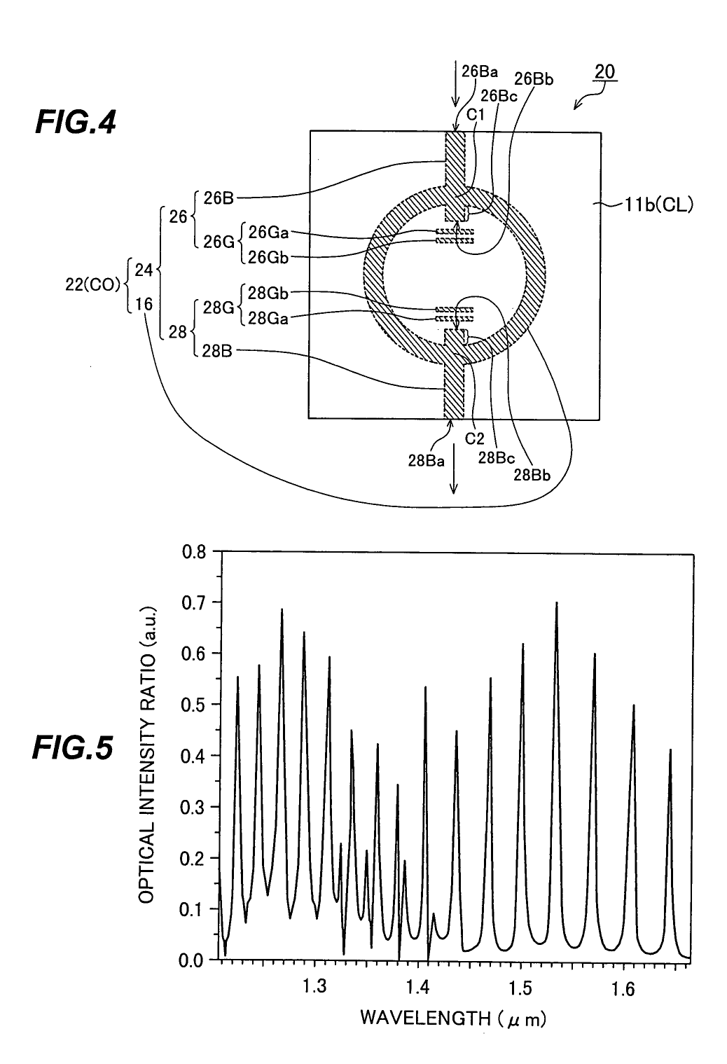

Referring to FIG. 4, the differences between the optical resonator 20 in the second embodiment and the optical resonator 10 (FIG. 1) in the first embodiment are that the input-output optical waveguide 24 includes two separate segments, referred to below as input-output optical waveguides 26, 28, with respective first ends 26Ba, 28Ba and second ends 26Bb, 28Bb. The input-output optical waveguide 24 also includes a grating 26G facing the second end 26Bb of the first input-output optical waveguide 26, and a grating 28G facing the second end 28Bb of the second input-output optical waveguide 28.

The input-output optical waveguide 24 itself is part of an optical waveguide 22, indicated by hatching, embedded in an upper substrate layer 11b. The upper substrate layer 11b rests on a lower substrate layer (not shown) as in FIG. 1. The optical waveguide 22 forms a core CO and the surrounding upper substrate layer 11b forms a clad CL. The core material in the optical resonator 20 is silicon, and the material of the clad CL is SiO₂, as in the first embodiment.

The optical waveguide 22 includes a ring-type optical waveguide 16 with the same dimensions as the ring-type optical waveguide 16 in the first embodiment. The first and second input-output optical waveguides 26, 28 both lie in the same plane as the ring-type optical waveguide 16 and both cross the ring-type optical waveguide 16 on the same line passing through the center of the ring formed by the ring-type optical waveguide 16, at respective locations C1 and C2. The first input-output optical waveguide 26 includes a main part 26B exterior to the ring and a back part 26Bc projecting inward from the ring. The second input-output optical waveguide 28 includes a main part 28B exterior to the ring and a back part 2BBc projecting inward from the ring.

The first end 26Ba of the first input-output optical waveguide 26 is an end of the main part 26B exposed on an edge facet of the upper substrate layer 11b. The second end 26Bb is the opposite end of the back part 26Bc. The preferred length of the back part 26Bc in the second embodiment is, for example, about 0.5 μm measured in the direction of light propagation.

Grating 26G includes two spaced-apart segments 26Ga, 26Gb facing the second end 26Bb, disposed so that if the second input-output optical waveguide 26 were to be extended toward the center of the ring it would pass through both segments 26Ga, 26Gb. Each one of the segments 26Ga, 26Gb has a preferred length of, for example, about 0.11 μm measured in the direction of light propagation. The preferred spacing between the segments 26Ga, 26Gb is, for example, about 0.26 μm.

Similarly, the first end 28Ba of the second input-output optical waveguide 28 is an end of the main part 28B exposed on another edge facet of the upper substrate layer 11b, and the second end 28Bb is the opposite end of back part 28Bc. The back part 28Bc has a preferred length of, for example, about 0.5 μm measured in the direction of light propagation. Grating 28G includes two spaced-apart segments 28Ga, 28Gb facing the second end 28Bb, similar to the segments 26Ga, 26Gb facing the second end 26Bb of the first input-output optical waveguide 26. Each segment 28Ga, 28Gb has a preferred length of, for example, about 0.11 μm, and the preferred spacing between the segments 28Ga, 28Gb is, for example, about 0.26 μm.

Next, the operation of the optical resonator 20 will be described.

Light enters the optical resonator 20 through the first end 26Ba of the first input-output optical waveguide 26, propagates through the first input-output optical waveguide 26 toward the ring-type optical waveguide 16, and reaches location C1. Part of the light is scattered at location C1 and coupled into the ring-type optical waveguide 16, where it begins to circulate.

The part of the light that is not scattered at location C1 propagates through the back part 26Bc of the first input-output optical waveguide 26 to grating 26G. Grating 26G reflects light of a specific wavelength (1.55 μm in the second embodiment) defined by the dimensions of grating 26G, propagates back through the back part 26Bc toward location C1, and is scattered at location C1. Part of the scattered light is coupled into the ring-type optical waveguide 16.

As the light coupled into the ring-type optical waveguide 16 circulates in the ring-type optical waveguide 16, light with a specific wavelength determined by the optical path length of the ring-type optical waveguide 16 is amplified by resonance. When the amplified light passes location C2, part of the light is scattered and coupled into the second input-output optical waveguide 28.

To ensure that amplified light of the desired wavelength is output to the second input-output optical waveguide 28, it suffices to adjust the optical path length of the ring-type optical waveguide 16 as explained in the first embodiment, thereby adjusting the phase of the light.

Part of the light coupled into the second input-output optical waveguide 28 propagates toward the first end 28Ba, where it exits the second input-output optical waveguide 28. Another part of the light propagates through the back part 28Bc, is reflected by grating 28G, and returns through the back part 28Bc. Part of the returning light is scattered at location C2, but the rest continues on through the main part 28B of the second input-output optical waveguide 28 and exits at the first end 28Ba.

The output characteristic of the optical resonator 20 is illustrated in FIG. 5. The vertical axis indicates the ratio of the intensity of the output light exiting the first end 28Ba of the second input-output optical waveguide 28 to the intensity of the input light entering the first end 26Ba of the first input-output optical waveguide 26, in arbitrary units. The horizontal axis indicates the wavelength of the light in micrometers. The curve indicates how the intensity of the output light exiting the first end 28Ba varies depending on the wavelength of the input light. This curve, like the curve in FIG. 2, was obtained by simulating the operation of the optical resonator 20 by the FDTD method.

Although the intensity peaks in FIG. 5 are less regular than in FIG. 2, they still appear at substantially harmonic intervals, and are generally higher than the peaks in FIG. 2. This is thought to be because in the optical resonator 20, the light that propagates through the back parts 26Bc, 28Bc of the input-output optical waveguide 24 is reflected toward locations C1, C2 by the gratings 26G, 28G and is partly coupled back into the ring-type optical waveguide 16 at these locations, and part of the light reflected by grating G2 propagates to the first end 28Ba of the second input-output optical waveguide 28 and becomes output light. Accordingly, the optical resonator 20 in the second embodiment has a higher light utilization efficiency than the optical resonator 10 in the first embodiment.

Like the optical resonator 10 in the first embodiment, the optical resonator 20 in the second embodiment has an extremely simple silicon-wire waveguide structure that is easy to fabricate by applying known semiconductor fabrication processes.

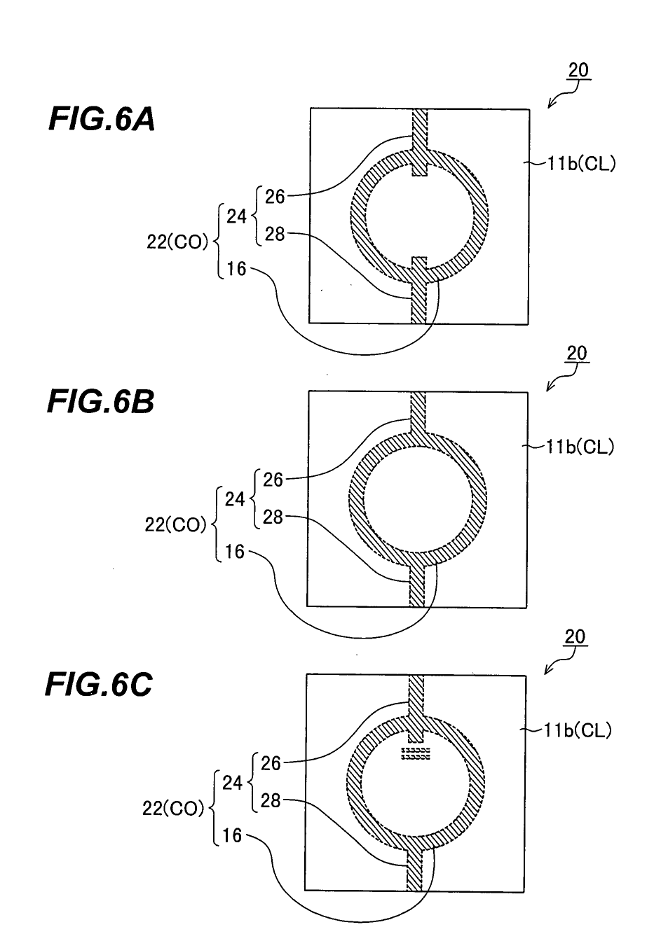

In a variation of the second embodiment, the gratings 26G, 28G are omitted as shown in FIG. 6A. An adequate light utilization efficiency is still obtained.

In another variation of the second embodiment, the gratings 26G, 28G are omitted and the first input-output optical waveguide 26 and the second input-output optical waveguide 28 meet the ring-type optical waveguide 16 in a T-shaped coupling configuration, as shown in FIG. 6B.

In yet another variation, the first input-output optical waveguide 26 crosses the ring-type optical waveguide 16 and has a grating while the second input-output optical waveguide 28 meets the ring-type optical waveguide 16 in a T-shaped coupling configuration, as shown in FIG. 6C.

The roles of the first and second input-output optical waveguides 26, 28 may be reversed. The second input-output optical waveguide 28 may be used for light input and the first input-output optical waveguide 26 for light output.

### Third Embodiment

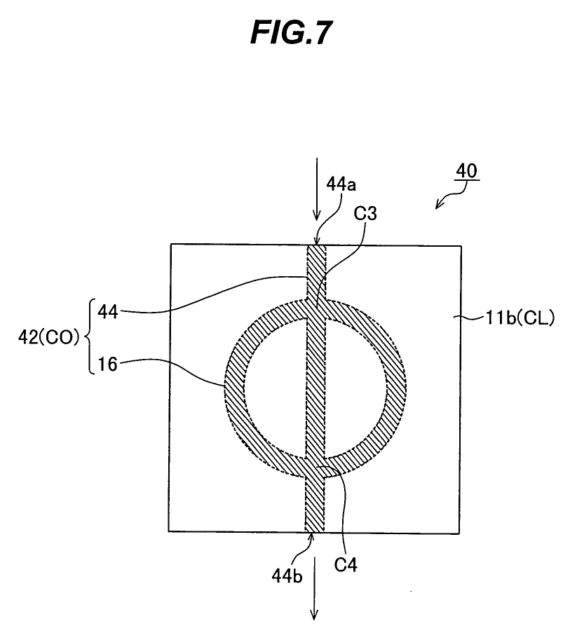

Referring to FIG. 7, the difference between the optical resonator 40 in the third embodiment and the optical resonator 10 in the first embodiment (FIG. 1) is that the input-output optical waveguide 44 crosses the ring-type optical waveguide 16 at two locations C3 and C4.

The input-output optical waveguide 44 and ring-type optical waveguide 16 in optical resonator 40 constitute an optical waveguide 42, indicated by hatching, embedded in the upper layer 11b of a substrate. The upper layer 11b rests on a lower substrate layer (not shown) as in FIG. 1. The optical waveguide 42 forms a core CO and the surrounding upper layer 11b forms a clad CL. The core material in the optical resonator 40 is silicon and the material of the clad CL is silicon dioxide (SiO₂), as in the first embodiment.

The ring-type optical waveguide 16 has the same dimensions as in the first embodiment. The input-output optical waveguide 44 is a single linear segment that lies in the same plane as the ring-type optical waveguide 16 and crosses the ring-type optical waveguide 16 at locations C3, C4 on a line passing through the center of the ring formed by the ring-type optical waveguide 16. The input-output optical waveguide 44 has two ends 44a, 44b exposed on opposite edge facets of the upper substrate layer 11b. Like the input-output optical waveguide 18 in the first embodiment, the input-output optical waveguide 44 has a square cross-section, with exemplary preferred cross-sectional dimensions of 0.3 μm high by 0.3 μm wide.

Next, the operation of the optical resonator 40 will be described.

Light enters the optical resonator 40 through the first end 44 of the input-output optical waveguide 44, propagates through the input-output optical waveguide 44 toward the ring-type optical waveguide 16, and reaches location C3. Part of the light is scattered at location C3 and coupled into the ring-type optical waveguide 16, in which it then circulates. The part of the light that is not scattered at location C3 propagates through the input-output optical waveguide 44 to location C4.

Some of this light is scattered at location C4 and coupled into the ring-type optical waveguide 16, where it circulates together with the light scattered at location C3. The part of the light that is not scattered at location C4 propagates through the input-output optical waveguide 44 to the second end 44b, and exits the input-output optical waveguide 44 at the second end 44b, becoming part of the output light.

As the light coupled into the ring-type optical waveguide 16 circulates in the ring-type optical waveguide 16, light with a specific wavelength defined by the optical path length of the ring-type optical waveguide 16 is amplified by resonance. When the amplified light passes location C4, part of the light is scattered and coupled into the input-output optical waveguide 44, and exits the input-output optical waveguide 44 at the second end 44b, becoming another part of the output light. To ensure that amplified light of the desired wavelength is output through the second end 44b, it suffices to adjust the optical path length of the ring-type optical waveguide 16 in the design stage, thereby adjusting the phase of the light.

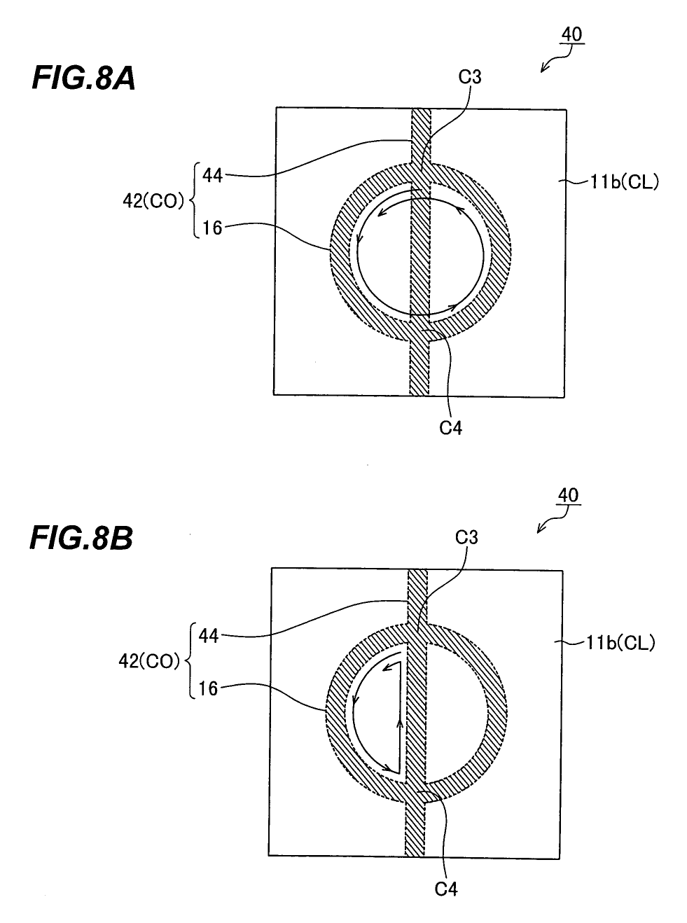

Since the input-output optical waveguide 44 crosses the ring-type optical waveguide 16 at two locations C3 and C4 in the optical resonator 40, light propagation paths having different optical path lengths are formed by the combination of the ring-type optical waveguide 16 and the input-output optical waveguide 44. Exemplary light propagation paths are shown in FIGS. 8A and 8B.

In the light propagation path in FIG. 8A, the light coupled into the ring-type optical waveguide 16 at location C3 propagates around the ring-type optical waveguide 16, passes location C3 again, and continues circulating in the ring-type optical waveguide 16. The resonant optical length of this path is determined by the circumference of the ring-type optical waveguide 16.

In the light propagation path in FIG. 8B, the light coupled into the ring-type optical waveguide 16 at location C3 propagates halfway around the ring-type optical waveguide 16, is scattered at location C4, propagates through the input-output optical waveguide 44, is scattered at location C3 again, and is thereby coupled back into the ring-type optical waveguide 16. The resonant optical length of this path is the sum of the diameter and half the circumference of the ring-type optical waveguide 16.

As described above, optical resonator 40 has a plurality of optical path lengths, and optical resonance occurs on each of the plurality of paths. Consequently, the resonance characteristic of optical resonator 40 differs from the resonance characteristic of optical resonator 10, which had a single resonant optical path length.

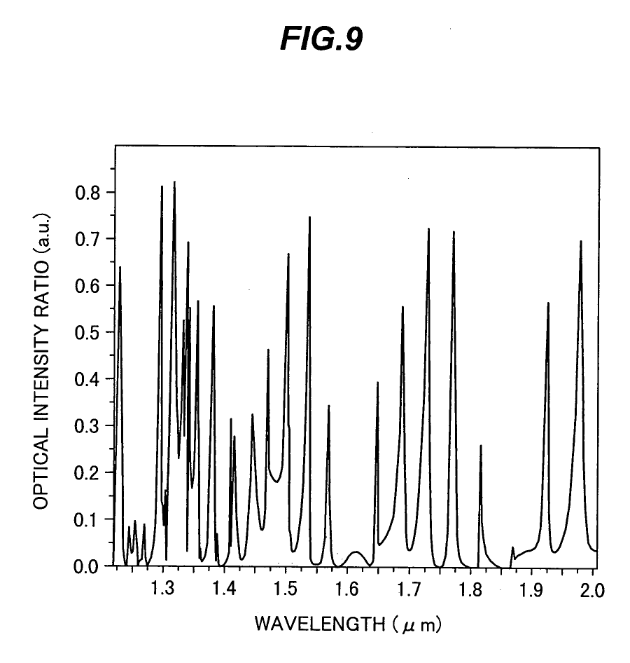

The output characteristic of optical resonator 40 is illustrated in FIG. 9. The vertical axis indicates the ratio of the intensity of the output light exiting the second end 44b to the intensity of the input light entering the first end 44a in arbitrary units. The horizontal axis indicates the wavelength of the light in micrometers. The curve indicates how the intensity of the output light exiting the second end 44b varies depending on the wavelength of the input light. This curve, like the curve in FIG. 2, was obtained by simulating the operation of the optical resonator 40 by the FDTD method.

Intensity peaks appear at irregular intervals, forming a seemingly random series, in contrast to the substantially regular series of intensity peaks in FIGS. 2 and 5. This is thought to be because in the optical resonator 40, the light waves that resonate on the different optical paths interfere with each other.

Although the optical resonator 40 has an irregular output wavelength characteristic, the light that propagates through the input-output optical waveguide 44 is coupled into the ring-type optical waveguide 16 at two locations C3, C4, so the optical resonator 40 has a higher light utilization efficiency and a higher intensity ratio of output to input light than the optical resonator 10 in the first embodiment.

Like the optical resonator 10 in the first embodiment, the optical resonator 40 in the third embodiment has an extremely simple silicon-wire waveguide structure that is easy to fabricate by applying known semiconductor fabrication processes.

### Fourth Embodiment

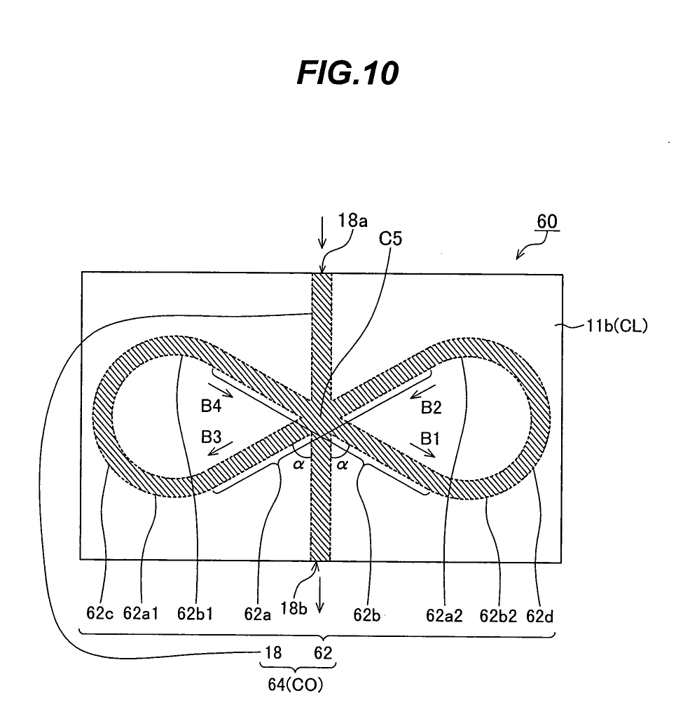

Referring to FIG. 10, the difference between the optical resonator 60 in the fourth embodiment and the optical resonator 10 in the first embodiment (FIG. 1) is that the ring-type optical waveguide 62 has a figure-eight configuration and crosses itself at a point C5. The input-output optical waveguide 18 is coupled to the ring-type optical waveguide 62 this intersection point C5.

The ring-type optical waveguide 62 and input-output optical waveguide 18 constitute a unitary optical waveguide 64, indicated by hatching, embedded in the upper layer 11b of a substrate. The upper layer 11b rests on a lower substrate layer (not shown) as in FIG. 1. The optical waveguide 64 forms a core CO and the surrounding upper layer 11b forms a clad CL. The core material is silicon and the clad material is silicon dioxide, as in the first embodiment.

The input-output optical waveguide 18 is a single linear segment with the same dimensions as in the first embodiment that lies in the same plane as the ring-type optical waveguide 62 and crosses the ring-type optical waveguide 62 at the intersection point C5 at which the ring-type optical waveguide 62 crosses itself. The ring-type optical waveguide 62 includes two linear segments 62a, 62b, and two circular arc segments 62c, 62d with identical radii. The preferred radius of curvature of each of the circular arc segments 62c, 62d in the fourth embodiment is, for example, about 3 μm. Arc segment 62c connects an end 62a1 of linear segment 62a to an end 62b1 of linear segment 62b; arc segment 62d connects the other end 62a2 of linear segment 62a to the other end 62b2 of linear segment 62b. The point C5 at which linear segment 62a crosses b62b is the midpoint of each linear segment 62a, 62b as measured in the direction of light propagation. The two linear segments 62a, 62b form equal angles a with the input-output optical waveguide 18 at location C5.

Next, the operation of the optical resonator 60 will be described.

Light enters the optical resonator 60 through the first end 18a of the input-output optical waveguide 18, propagates through the input-output optical waveguide 18 toward the ring-type optical waveguide 62, and reaches location C5. Part of the light is scattered at location C5 and coupled into the ring-type optical waveguide 62 in which it circulates. The part of the light that is not scattered at location C5 propagates through the input-output optical waveguide 18 to its second end 18b and exits the input-output optical waveguide 18.

The light coupled into the ring-type optical waveguide 62 propagates through the ring-type optical waveguide 62 in the direction of arrows B1, B2, B3, B4, or in the opposite direction. As the light coupled into the ring-type optical waveguide 62 circulates in the ring-type optical waveguide 62, light with a specific wavelength defined by the optical path length of the ring-type optical waveguide 62 is amplified by resonance. When the amplified light passes location C5, part of the light is scattered and coupled into the input-output optical waveguide 18, and exits the input-output optical waveguide 18 at the second end 18b. To ensure that amplified light of the desired wavelength is output through the second end 18b, it suffices to adjust the optical path length of the ring-type optical waveguide 62 in the design stage, thereby adjusting the phase of the light.

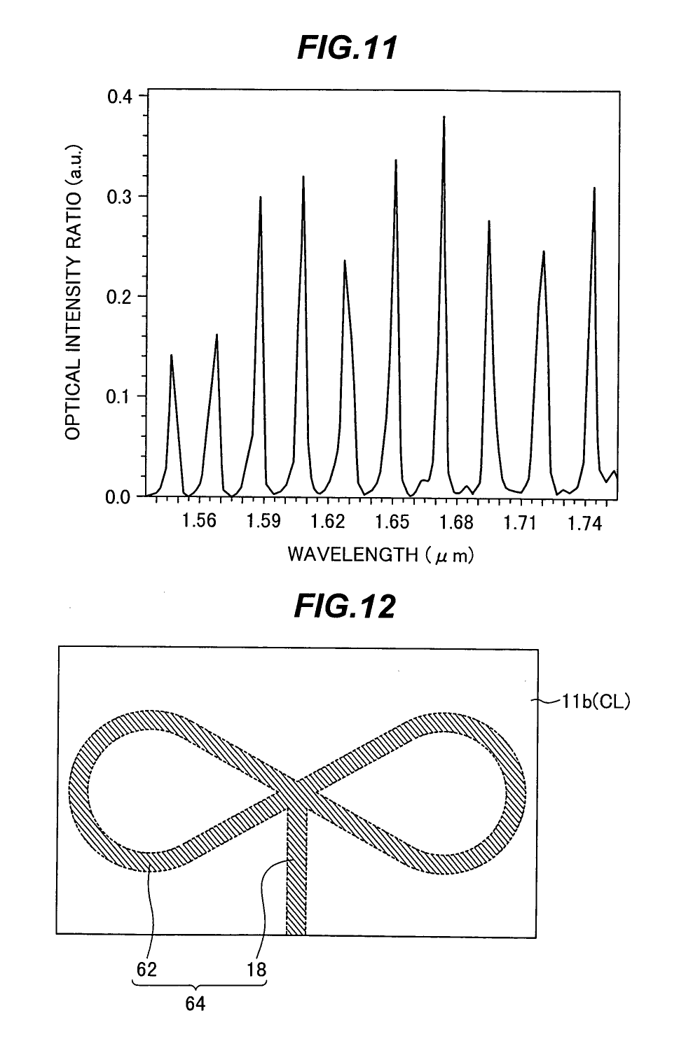

The output characteristic of the optical resonator 60 is illustrated in FIG. 11. The vertical axis indicates the ratio of the intensity of the output light exiting the second end 18b to the intensity of the input light entering the first end 18a in arbitrary units. The horizontal axis indicates the wavelength of the light in micrometers. The curve indicates how the intensity of the output light exiting the second end 18b varies depending on the wavelength of the input light. This curve, like the curve in FIG. 2, was obtained by simulating the operation of the optical resonator 60 by the FDTD method.

Intensity peaks appear at regular intervals, indicating that the optical resonator 60 operates as a classical optical resonator having a single optical path length. The intervals in FIG. 11 are longer than the intervals in FIGS. 2, 5, and 9. This is thought to be because the optical path length of optical resonator 60 is longer than the optical path lengths of optical resonators 10, 20, and 40.

Like the optical resonator 10 in the first embodiment, the optical resonator 60 in the fourth embodiment has an extremely simple silicon-wire waveguide structure that is easy to fabricate by applying known semiconductor fabrication processes.

In a variation of the fourth embodiment, the input-output optical waveguide 18 meets but does not cross the ring-type optical waveguide 62, extending in just one direction from the intersection point as shown in FIG. 12.

In all of the preceding embodiments, the cross-sectional dimensions of the input-output optical waveguides, orthogonal to the direction of light propagation, may be modified to change the characteristics of their coupling with the ring-type optical waveguides. Specifically, the cross-sectional dimensions of the input-output optical waveguides may be reduced to improve the efficiency with which light is coupled into the ring-type optical waveguides.

In all of the preceding embodiments, an active region may be formed in part of the ring-type optical waveguide so that the optical resonator functions as a laser light source. In this case the input-output optical waveguide may function only for optical output.

Those skilled in the art will recognize that further variations are possible within the scope of the invention, which is defined in the appended claims.

What is claimed is:

1. An optical resonator including an optical waveguide with a core surrounded by a clad, the core having a higher refractive index than the clad, the optical waveguide comprising:
a non-terminated ring-type optical waveguide for resonant propagation of light; and
a input-output optical waveguide for guiding light out from the ring-type optical waveguide, or into and out from the light from the ring-type optical waveguide, the input-output optical waveguide being unitarily coupled to the ring-type optical waveguide.

2. The optical resonator of claim 1, wherein the ring-type optical waveguide is circular.

3. The optical resonator of claim 2, wherein the input-output optical waveguide is a single linear segment.

4. The optical resonator of claim 3, wherein the ring-type optical waveguide and the input-output optical waveguide meet in a right-angled T-shaped configuration.

5. The optical resonator of claim 3, wherein the ring-type optical waveguide and the input-output optical waveguide meet in an acute-angled T-shaped configuration.

6. The optical resonator of claim 3, wherein the input-output optical waveguide crosses the ring-type optical waveguide.

7. The optical resonator of claim 6, wherein the input-output optical waveguide crosses the ring-type optical waveguide at a single location.

8. The optical resonator of claim 6, wherein the input-output optical waveguide crosses the ring-type optical waveguide at two locations.

9. The optical resonator of claim 2, wherein the input-output optical waveguide has two linear segments.

10. The optical resonator of claim 9, wherein each one of the two linear segments meets the ring-type optical waveguide in a T-shaped configuration.

11. The optical resonator of claim 9, wherein each one of the two linear segments crosses the ring-type optical waveguide.

12. The optical resonator of claim 9, wherein one of the two linear segments crosses the ring-type optical waveguide and another one of the two linear segments meets the ring-type optical waveguide in a T-shaped configuration.

13. The optical resonator of claim 9, wherein at least one of the two linear segments crosses the ring-type optical waveguide and has an inside end disposed inward of the ring-type optical waveguide, the optical resonator further comprising a reflective grating facing said inside end.

14. The optical resonator of claim 1, wherein the ring-type optical waveguide has a figure-eight configuration.

15. The optical resonator of claim 12, wherein the input-output optical waveguide is a single linear segment.

16. The optical resonator of claim 13, wherein the figure-eight configuration crosses itself at an intersection point, and the input-output optical waveguide is coupled to the ring-type optical waveguide at the intersection point, extending from the intersection point in two directions.

17. The optical resonator of claim 13, wherein the figure-eight configuration crosses itself at an intersection point, and the input-output optical waveguide is coupled to the ring-type optical waveguide at the intersection point, extending from the intersection point in just one direction.

18. The optical resonator of claim 1, wherein the core comprises silicon and the clad comprises silicon dioxide.

19. The optical resonator of claim 1, wherein the clad has a first refractive index and the core has a second refractive index at least 1.4 times as great as the first refractive index.

20. A laser light source comprising the optical resonator of claim 1, wherein the optical resonator has an active region disposed in part of the ring-type optical waveguide.
